(19) United States
(12) Patent Application Publication
(10) Pub. No.: US 2024/0144123 A1
(43) Pub. Date: May 2, 2024

(54) STRESS TRACKING AND MANAGEMENT

(71) Applicant: Avaya Management L.P., Durham, NC (US)

(72) Inventors: Raghav Krishnakant Kanojia, Vadodara (IN); Gaurang Jayantibhai Gohil, Ahmedabad (IN); Rajeswara rao Nagaraju, Srikakulam (IN); Dhaval Bharatbhai Patel, Pune (IN)

(21) Appl. No.: 17/977,660

(22) Filed: Oct. 31, 2022

(51) Int. Cl. G06Q 10/06; G10L 25/63

(52) U.S. Cl. CPC G06Q 10/06312; G06Q 10/06398; G10L 25/63

(57) ABSTRACT

Some degree of stress in the workplace is expected and unavoidable. However, when people experience too much stress, the detrimental effects can impact the health of individuals as well as impact the organization in the form of absenteeism, reduced productivity, and other issues. By considering the stress for events of a schedule, the events may be determined to produce an aggregate stress that is unnecessarily high. In response, systems and methods herein are provided to determine which events are stressful and recalculate a schedule in order to reduce the stress on the people performing the constituent tasks. A recalculated schedule is then published to allocate equipment, supplies, personnel, etc. with a lesser degree of stress experienced by the users thereof.

### FIELD OF THE DISCLOSURE

The invention relates generally to systems and methods for automatically scheduling a resource of a system and particularly to scheduling a resource while reducing workplace stress.

### BACKGROUND

Stress is a well-known source of health issues, such as insomnia and heart disease, and work-related issues, such as poor job performance and dissatisfaction. In a work setting, some level of stress may always be present with the dividing line between acceptable and not acceptable levels of stress being difficult to identify, in part because the level of stress that is considered excessive varies from person to person or for one person over time. However, people generally know when they are experiencing an unacceptable level and/or duration of stress or that they are experiencing the effects of excessive stress.

Knowing when someone is experiencing excessive work-related stress can be difficult for an employer to determine. Signs of excessive stress may be revealed in various ways, such as absenteeism, poor performance, and disengagement. However, it is not uncommon for the first sign of excessive work-related stress to be revealed to an employer when an employee quits, and it is too late to take any corrective action. Accordingly, it would be beneficial to determine when employees are experiencing excessive stress and to take corrective action to reduce or manage the stress to promote employee health and job satisfaction and reduce turnover.

### SUMMARY

Systems and methods to assign and track employee tasks and meetings are known in the prior art. Such systems and methods consider factors like availability but fail to consider factors such as stress level. In some circumstances, the source of the stress may be a high workload for tasks that are not well managed or monitored. For example, the prior art can readily determine how much time an employee spends on calls or the number of emails they send and receive. However, employees often have other responsibilities that are more difficult to monitor, such as research and self-teaching, informal training or assisting of coworkers, thinking about a prior issue or tasks when another work item should be the focus, issues that are more protracted due to system limitations, and personal issues. Any one or more of these factors can affect the stress level and, if not managed, can be detrimental for the employee and employer.

These and other needs are addressed by the various embodiments and configurations of the present invention. The present invention can provide a number of advantages depending on the particular configuration. These and other advantages will be apparent from the disclosure of the invention(s) contained herein.

In one embodiment, systems, such as conferencing or remote collaboration systems and applications, are provided with functionality to monitor and manage an individual's tasks and meetings. Additionally or alternatively, an artificial intelligence (AI), such as a neural network, is trained to detect stress levels for users of the systems. With stress levels known, whether as a single point or a trend over time, the workflow for the user (e.g., an employee of an organization) may be managed to mitigate the effects of excessive stress.

Stress management may occur by altering a workload of a user, such as by reducing the number or frequency of high-stress tasks or increasing the number or frequency of low-stress tasks.

In another embodiment, the AI system is trained with a number of inputs including, but not limited to, a user's voice, meeting schedules, work hours and times, workload (e.g., number of tasks, number of interpersonal interactions, task attributes, etc.), and completion time for the tasks.

Exemplary aspects are directed to:

A system for scheduling a resource, comprising: a microprocessor; and a computer-readable medium coupled to the microprocessor, the medium comprising one or more computer-readable instructions, the microprocessor executing the one or more computer-readable instructions to: access a default event schedule comprising a plurality of events to be attended by a user; access an event stress corresponding to each of the plurality of events; access a stress threshold associated with the user; determine whether the configuration of the plurality of events in the default schedule will produce an aggregate stress, determined from the combination of event stresses for each of the plurality of events, will exceed the stress threshold; upon determining the stress threshold will not be exceeded, publish the default event schedule to a repository to automatically configure the resource allocated with the default event schedule; and upon determining the stress threshold will be exceeded, recalculate the default event schedule to create a modified event schedule that attenuates the aggregate stress and publish the modified event schedule to the repository to automatically configure the resource allocated with the modified event schedule.

A method for scheduling a resource, comprising: accessing a default event schedule comprising a plurality of events to be attended by a user; accessing an event stress corresponding to each of the plurality of events; accessing a stress threshold associated with the user; determining whether the configuration of the plurality of events in the default schedule will produce an aggregate stress, determined from the combination of event stresses for each of the plurality of events, will exceed the stress threshold; upon determining the stress threshold will not be exceeded, publishing the default event schedule to a repository to automatically configure the resource allocated with the default event schedule; and upon determining the stress threshold will be exceeded, recalculating the default event schedule to create a modified event schedule that attenuates the aggregate stress and publishing the modified event schedule to the repository to automatically configure the resource allocated with the modified event schedule.

A system, comprising: a server, the server further comprising at least one microprocessor and a computer-readable medium coupled to each of the at least one microprocessor, the medium comprising one or more computer-readable instructions, the at least one microprocessor executing the one or more computer-readable instructions to: access a default event schedule comprising a plurality of events to be attended by a plurality of users; access an event stress corresponding to each of the plurality of events; access a stress threshold associated with each of the plurality of users; determine whether the configuration of the plurality of events in the default schedule will produce an aggregate stress, determined from the combination of event stresses for each of the plurality of events, will exceed the stress threshold for at least one of the plurality of users; upon determining the stress threshold will not be exceeded, publish the default event schedule to a repository to automatically configure the resource allocated with the default event schedule; and upon determining the stress threshold will be exceeded, recalculate the default event schedule to create a modified event schedule that attenuates the aggregate stress and publish the modified event schedule to the repository to automatically configure the resource allocated with the modified event schedule.

A system on a chip (SoC) including any one or more of the above aspects or aspects of the embodiments described herein.

One or more means for performing any one or more of the above aspects or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a process in accordance with embodiments of the present disclosure;

FIG. 3 depicts another process in accordance with embodiments of the present disclosure; and

FIG. 4 depicts a device in system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

The use of terms for people (e.g., “user”, “employee,” “individual”, etc.) may be used interchangeably to mean a human being which may be specifically identified, such as when accompanied with a reference numeral, or more generically to refer to any human but not necessarily a particular human, such as a human that may have been referenced elsewhere.

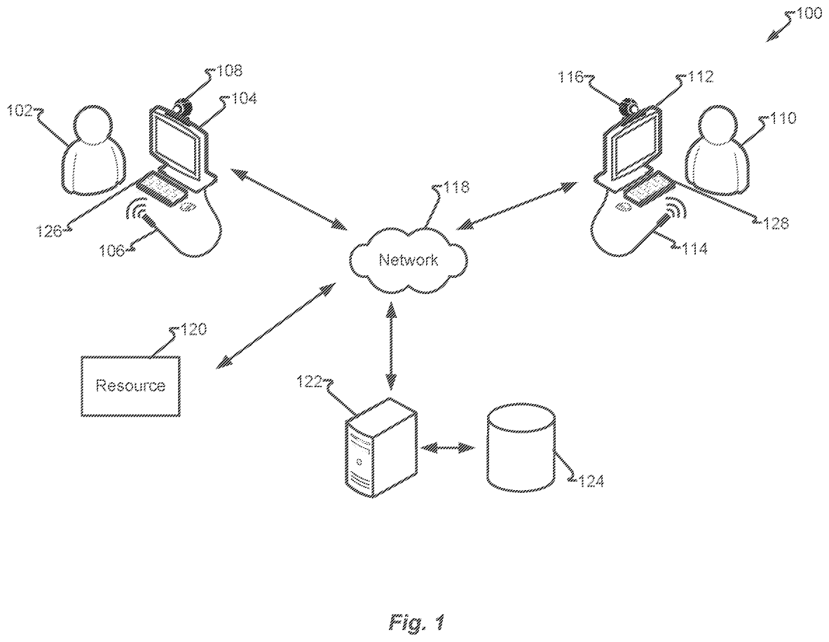

FIG. 1 depicts system 100 in accordance with embodiments of the present disclosure. In one embodiment, user 102, user 110, resource 120, and server 122 each comprise a network interface to enable communications via network 118. Data storage 124 may be in communication with, or a component of, server 122 and/or communicate via network 118 via user device 112 or directly as a stand-alone component. It should be appreciated by those of ordinary skill in the art that system 100 illustrates components in one topology but which may be altered to another topology without departing from the scope of the embodiments herein.

User 102 and user 110 are human beings and, via user device 104 and user device 112, respectively, are portions of system 100. Mental stress or stress levels that are elevated beyond a baseline level for a particular setting, such as a work environment (herein simply “stress”), are a component of many aspects of life including such a work environment to which system 100 is directed. However, individuals (e.g., user 102, user 110, etc.) may be exposed to the same or different stressors as a part of their jobs and/or handle the stress differently. Outside stressors (e.g., family life, health concerns, financial difficulties, etc.) may further contribute to a level of stress and/or how the stress is handled. As a result, a particular sequence of events (e.g., meetings, tasks to complete, etc.) may inflict stress on individuals differently. Those with a higher degree of stress may have health issues or work performance issues, or they may leave their current employment regardless of their ability to perform the work.

In one embodiment, user 102 utilizes networked components, such as user device 104 as a communication device to communicate with others and/or to perform other tasks. User device 104 may comprise, or have peripheral thereto, a number of monitoring components. The monitoring components may be dedicated devices that solely perform a monitoring purpose, such as a room monitoring camera (not shown). Additionally or alternatively, the monitoring component may be utilized for another purpose, such as conducting voice, video, and/or textual communications. Accordingly, microphone 106 may capture sound (e.g., speech from user 102) during a conference with another party and perform a stress analysis on the captured sound to determine a degree of stress associated with the particular conference. Additionally or alternatively, microphone 106 may capture sound at times other than during a conference (e.g., time before a conference, time after a conference, perpetually, intermittently, etc.). Similarly, camera 108 may capture images including an image of user 102 and analyze the image for indications of stress. For example, facial expressions, body position and movement, eye movement, etc., may indicate a degree of stress for user 102. Also similarly, keyboard 126 may receive physical keystrokes as an input to create a message, such as a text chat portion of a conference or during other tasks. The particular typing pattern may then be analyzed for indications of stress, such as a typing rate, errors that were corrected before the message was sent, force applied to the keys, etc. Certain typing attributes, and their associated indications of stress, may be provided by output signals received from a number of monitoring components. For example, keyboard 126 may not report a force applied to the keys; however, camera 108 may capture user 102 making exaggerated movements (e.g., typing each letter from a hand motion starting at eye-level) and/or the sound of the keys being hit as captured from an output signal of microphone 106.

In another embodiment, the words and phrases spoken or typed by user 102 may indicate an elevated degree of stress. For example, if user 102 commonly uses a particular phrase or number of words (e.g., “Glad I could help. Is there anything more I can do for you?”) such as during times known to be low stress but uses different words or a different number of words (e.g., “That's done. Anything else?”) that have the same meaning, stress may be determined to be present.

Similarly, user 110 may be monitored by monitoring components including microphone 114, camera 116, keyboard 128, or a combination thereof. The analysis of the output from the monitoring components may be performed by a microprocessor of user device 104, user device 112, and/or server 122. Additionally or alternatively, a microprocessor may have access to data storage 124 which may include calendar information for user 102 and/or user 110. For example, data storage 124 may comprise a database having a calendar record showing an employee (e.g., user 102) is scheduled to have a call with user 110, which may be known to user 102 as a difficult customer or unhappy boss. Accordingly, server 122 may observe user 102 via the output signals from monitoring components (e.g., microphone 106, camera 108, keyboard 126, etc.) to determine a degree of stress. The observations may be performed, before, during, and/or after the scheduled event. Similarly, user 102 may be engaged in a call with user 110 without such a call being on a calendar. Server 122 may analyze the speech, documents, text, and/or other content exchanged between user 102 and user 110 to determine a subject and associate the subject with a stress level in a record written to data storage 124.

Once a number of stress events are known for a corresponding number and/or type of events (e.g., performance review, customer call, etc.) server 122 may predict a level of stress for a future event or series of events. Such predictions may be beneficial for unscheduled events (e.g., receiving customer complaints) if the unscheduled events, at least partially, occur with regularity. Mitigating stress may include reducing the frequency, duration, and/or degree of high-stress events and/or increasing the frequency, duration, and/or degree of low-stress recovery periods therebetween. For example, including more tasks known to be stress reducers may be interspersed between more stressful events. In other embodiments, a schedule may include a number of events, each having an associated event stress. If a particular series of events, such as a schedule to complete a project, is known to have an aggregate stress score of the constituent events that is above a threshold for at least one user, the schedule may be recalculated such as to reassign one or more high-stress events to another user, rearrange the order of tasks so that neutral-stress/low-stress tasks are inserted between high-stress events, etc. Ideally, and in one embodiment, the resulting reordering produces an identical outcome, such as the same result at substantially the same time. In another embodiment, the result differs but within an acceptable range, such as an equivalent benefit. For example, if a default schedule would deliver a product in eleven months but a recalculated schedule delivers the product in twelve months, there is likely a measurable cost to the additional month. However, the reduction of stress on the part of the users involved in the delivery may be improved in terms of reduced turnover, absenteeism, illness, effectiveness, workplace satisfaction, etc. (i.e., the benefit). Accordingly, a cost-benefit analysis may reveal that a default schedule, such as one that only considers the fastest time to completion, may not be as advantageous as compared to the recalculated schedule that reduces user stress.

In another embodiment, resource 120 is, or will be, configured in accordance with a default schedule. Resource 120 is variously embodied. In one embodiment, resource 120 is a user (similar to user 102 utilizing user device 104, user 110 utilizing user device 112, or other user), more specifically, it is a time or task to which the user is allocated and, in a further embodiment, the equipment (e.g., networking device, servers, communication components, etc.) utilized by, or on behalf of, the user (a tool, a communication device, a networking port, etc.). In other embodiments, resource 120 is, or is a component of, a system comprising at least one physical component, for example, a communication or computational device, manufacturing equipment, environmental control device, transportation machine, etc. The configuration may comprise configuring resource 120 with consumables (e.g., components to be assembled in a manufacturing process), a component (e.g., a specific die used to stamp a component), and/or allocate resource 120 to be unavailable for other purposes (e.g., a networking trunk is, at least partially, made unavailable for other purposes and refuses communications while allocated).

A default schedule may be initially developed or accessed that allocates resource 120. The default schedule may consider a variety of finite factors which may depend on the particular embodiment of resource 120. For example, when resource 120 is manufacturing equipment, resource 120 may include the availability and acquisition of the components to be processed and the time to perform such processing, wherein resource 120 is unavailable to perform other tasks. When resource 120 is a user, the factors may include scheduling conflicts; availability of a communication device, such as user device 104, required to be utilized by the user; a requirement to be in a particular physical location, etc.

The default schedule may be recalculated to consider stressors, as discussed above, to produce a different schedule and, in doing so, a reduced stress level for one or more users. In another embodiment, the initial development of the schedule already including consideration of the stress level for the users involved and recalculation to reduce stress, described herein, are incorporated in the initial schedule. Through happenstance or initial consideration, the default schedule considers stress or otherwise cannot be improved upon to further reduce the stress. In such situations, the default schedule may be published. When the default schedule is recalculated, such as to produce a modified event schedule, the modified event schedule is then published. Publishing a schedule is variously embodied and may include allocation of equipment (e.g., machinery, network ports, etc.), deallocating equipment used for other purposes that conflict with the allocated equipment (e.g., insufficient electrical power to operate both the allocated equipment and the equipment used for other purposes; requirement of a physical space needed for the allocated equipment, etc.), automatically adding events to a user's calendar, automatically provisioning supplies, automatically establishing communications between networked components (e.g., user device 104, user device 112, resource 120, server 122, etc.). Publishing may also include reports to users, managers, and/or other stakeholders to provide guidance as to what projects or events are stressful and/or the user's response to the stressors.

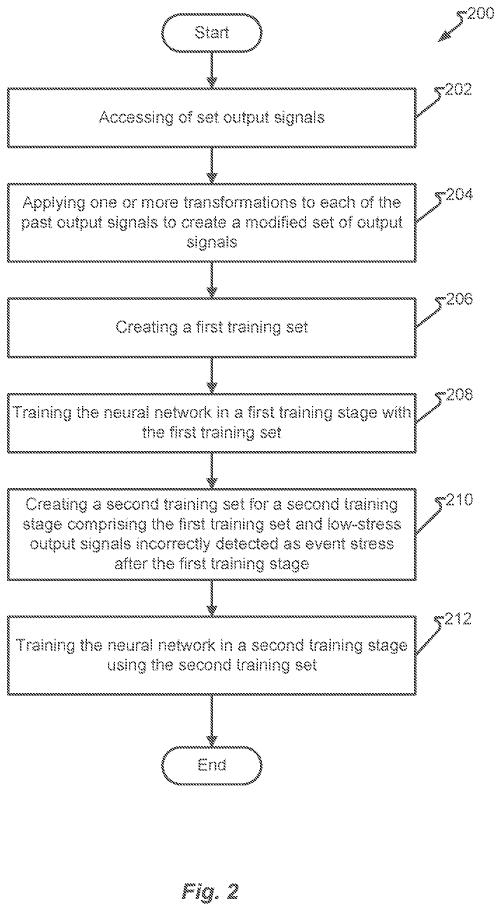

FIG. 2 depicts process 200 in accordance with embodiments of the present disclosure. Determining the degree of stress of an event on a particular individual (e.g., user 102, user 110, etc.) is variously embodied. Individuals may perceive, respond, and indicate stress differently from one another. User 102 may explicitly identify stressful and/or less stressful situations (e.g., “Working with customer Alpha is very stressful,” “Working with customer Beta is much less stressful for me,” etc.). Observing humans, such as via monitoring components (e.g., camera 108, microphone 106, keyboard 126, microphone 114, camera 116, keyboard 128, etc.) may determine when stress above a baseline level is being experienced by a user (e.g., user 102, user 110, etc.). For example, humans generally have similar responses to very high levels of stress. An emergency or other extremely high-stress situation may result in dilated eyes, more abrupt movements, higher blood pressure, higher perspiration, higher respiration, tremors, etc., for all individuals experiencing the emergency. Any one or more of the foregoing may be experienced, but to a lesser degree, for any situation where the individual is experiencing elevated stress levels. However, such indicators may be difficult to read or conflict with each other. Accordingly, and in one embodiment, artificial intelligence, such as a neural network, is trained and provided with output signals from monitoring equipment to determine if a user (e.g., user 102, user 110, etc.) is experiencing a stressful event.

A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive.

In one embodiment, process 200 is embodied as machine-readable instructions maintained in a non-transitory memory that when read by a machine, such as microprocessors of a server, cause the machine to execute the instructions and thereby execute process 200. The microprocessors of the server may include, but are not limited to, at least one processor of server 122 or other computing device, such as user device 104, user device 112, etc.

In one embodiment, process 200 begins, and step 202 accesses a set of output signals, such as past output signals, or indicia thereof, maintained in data storage 124. The set of output signals accessed may comprise output signals for a specific user. For example, output signals from monitoring component (e.g., camera 108, microphone 106, keyboard 126, etc.) configured to monitor a specific user (e.g., user 102). Additionally or alternatively, the set of output signals may be captured from monitoring components (e.g., camera 116, microphone 114, keyboard 128, etc.) for other or additional users (e.g., user 110). As a benefit, new employees may have a set of generalized stress responses available from other sources rather than an empty set. If any one or more output signals do not apply, the neural network may be periodically, intermittently, or continuously retrained to tailor the output signals and stress indications to the new employee as more data becomes available.

Step 204 applies one or more transformations to each of the past output signals to create a modified set of output signals. Past output signals may include increasing the rate of speech, decreasing the rate of speech, increasing the amount of speech flutter (e.g., warble), decreasing the amount of speech flutter, increasing the pitch of speech, decreasing the pitch of speech, increasing a rate of typing, decreasing the rate of typing, replacing a typed word with a synonymous word or words having a different stress value, altering eye movement of the user, altering facial expression of the user, or altering body position of the user to create a modified set of output signals.

Step 206 then creates a first training set comprising the collected set of output signals, the modified set of output signals, and a set of low-stress output signals. Low-stress output signals may be generated (e.g., a simulation) or observed such as when the output signals from one or more monitoring components are monitoring a user known to be attending to a previously determined or otherwise known task or event that is low stress. Next, step 208 trains the neural network in a first training stage using the first training set. Step 210 then creates a second training set for a second training stage comprising the first training set and low-stress output signals incorrectly detected as event stress after the first training stage. Step 212 trains the neural network in the second training stage using the second training set.

In another embodiment, the neural network may be retrained continuously or intermittently, such as in response to feedback from the user. Once trained, the neural network may be provided with output signals from monitoring components, whether recorded or in real time, and determine therefrom whether the subject (e.g., user 102, user 110, etc.) is stressed during an event, such as a task.

In one embodiment, process 200 is embodied as machine-readable instructions maintained in a non-transitory memory that when read by a machine, such as microprocessors of a server, cause the machine to execute the instructions and thereby execute process 200. The microprocessors of the server may include, but are not limited to, at least one processor of server 122 or other computing device, such as user device 104, user device 112, etc.

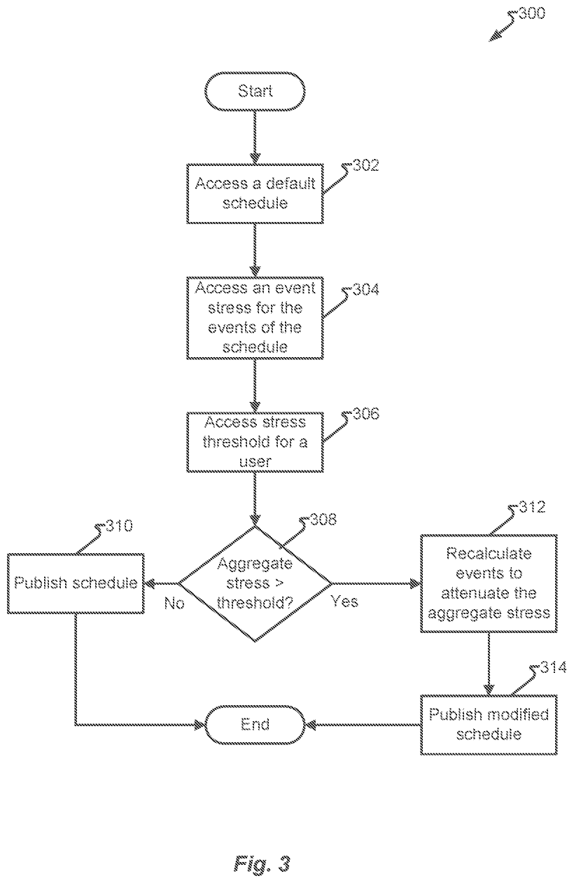

FIG. 3 depicts process 300 in accordance with embodiments of the present disclosure. In one embodiment, process 300 is embodied as machine-readable instructions maintained in a non-transitory memory that when read by a machine, such as microprocessors of a server, cause the machine to execute the instructions and thereby execute process 300. The microprocessors of the server may include, but are not limited to, at least one processor of server 122 or other computing device, such as user device 104, user device 112, etc.

Process 300 begins and, in step 302, accesses a default schedule, such as a schedule that allocates a resource and considers certain factors, such as time to completion, resource costs, soonest resource availability, etc. Wherein a resource may be equipment, financial, feed stock/consumables, energy inputs, physical space, personnel, etc. However, for the default schedule, stress factors for the users who are or will be associated with at least one task is not considered. Next, step 304 accesses an event stress for the events in the schedule. Step 304 may produce an aggregate stress for the schedule comprised of the event stresses for the constituent events of the schedule. The event stress for the constituent events is variously embodied. For example, a scale of 1-10, an enumeration (e.g., very low, low, medium, high, very high) may be assigned as an event stress for a corresponding event. An aggregate stress score, such as one for a schedule comprising two or more events, may be an average, weighted average, median, mode, or other aggregation. Additionally or alternatively, the aggregation itself may include other factors, such as the time between high (or higher) stress events, such as time a user spends performing other scheduled events (and their respective event stress) or events not associated with any event (e.g., rest, sleep, vacation, time on other projects, etc.). The aggregate score may similarly be a scale, enumeration, or other indicia of the degree of stress provided. In one embodiment, the aggregate score is not specific to any user, such as when the individual stress events are values determined by a sufficiently large number of users. In another embodiment, the aggregate score is specific to a user. For example, “Task A” has an event stress value of 7 for user 102, but only a 5 for user 110. The resulting aggregation reflects the specific user.

Step 306 accesses a stress threshold for a particular user and, in test 308, compares the value to the aggregate score. If test 308 is determined in the negative, step 310 publishes the default schedule, such as to configure at least one resource in accordance with the events and their ordering therein. If test 308 is determined in the affirmative, step 312 recalculates the events to attenuate the aggregate stress (e.g., reorder to include low-stress events between high stress events, reassign events from one user to another, insert recovery tasks, provide prompts to a user of start/stop times, reschedule events, alter delivery milestones, etc.). The resulting modified schedule is then published in step 314 and the resource configured accordingly.

It should be appreciated that steps of process 300 may be repeated, such as for each user having at least one event, so as to minimize stress for one user, a subset of users, or all users.

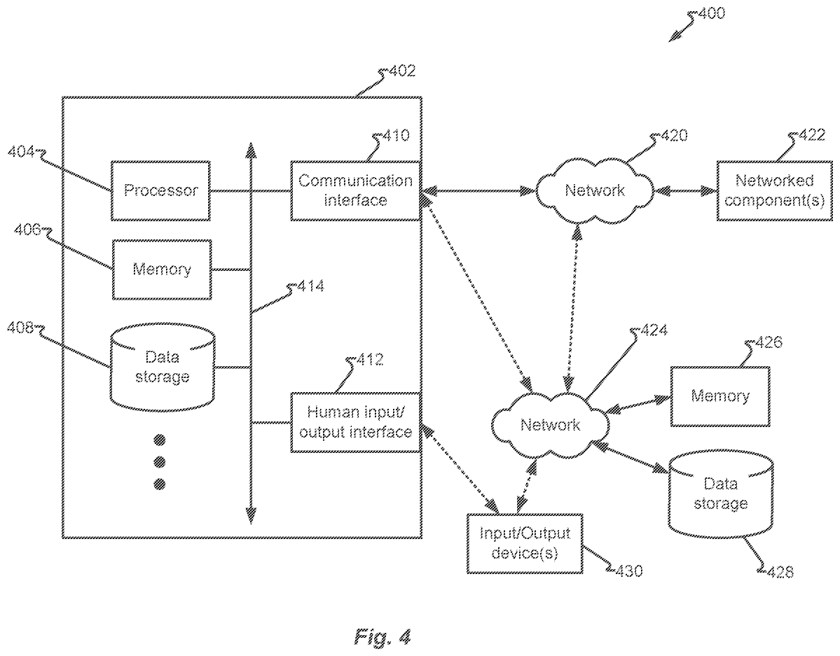

FIG. 4 depicts device 402 in system 400 in accordance with embodiments of the present disclosure. In one embodiment, server 122, user device 104, and/or user 110 may be embodied, in whole or in part, as device 402 comprising various components and connections to other components and/or systems. The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may comprise programmable logic functionality, such as determined, at least in part, from accessing machine-readable instructions maintained in a non-transitory data storage, which may be embodied as circuitry, on-chip read-only memory, computer memory 406, data storage 408, etc., that cause the processor 404 to perform the steps of the instructions. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize computer memory 406 and/or data storage 408 for the storage of accessible data, such as instructions, values, etc. Communication interface 410 facilitates communication with components, such as processor 404 via bus 414 with components not accessible via bus 414. Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or configured to utilize one or more networks, such as network 420 and/or network 424.

Network 118 may be embodied, in whole or in part, as network 420. Network 420 may be a wired network (e.g., Ethernet), wireless (e.g., WiFi, Bluetooth, cellular, etc.) network, or combination thereof and enable device 402 to communicate with networked component(s) 422. In other embodiments, network 420 may be embodied, in whole or in part, as a telephony network (e.g., public switched telephone network (PSTN), private branch exchange (PBX), cellular telephony network, etc.).

Additionally or alternatively, one or more other networks may be utilized. For example, network 424 may represent a second network, which may facilitate communication with components utilized by device 402. For example, network 424 may be an internal network to a business entity or other organization, whereby components are trusted (or at least more so) than networked components 422, which may be connected to network 420 comprising a public network (e.g., Internet) that may not be as trusted.

Components attached to network 424 may include computer memory 426, data storage 428, input/output device(s) 430, and/or other components that may be accessible to processor 404. For example, computer memory 426 and/or data storage 428 may supplement or supplant computer memory 406 and/or data storage 408 entirely or for a particular task or purpose. As another example, computer memory 426 and/or data storage 428 may be an external data repository (e.g., server farm, array, “cloud,” etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of computer memory 406, data storage 408, computer memory 426, data storage 428 comprise a non-transitory data storage comprising a data storage device.

It should be appreciated that computer-readable data may be sent, received, stored, processed, and presented by a variety of components. It should also be appreciated that components illustrated may control other components, whether illustrated herein or otherwise. For example, one input/output device 430 may be a router, a switch, a port, or other communication component such that a particular output of processor 404 enables (or disables) input/output device 430, which may be associated with network 420 and/or network 424, to allow (or disallow) communications between two or more nodes on network 420 and/or network 424. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system for scheduling a resource, comprising:
a microprocessor; and
a computer-readable medium coupled to the microprocessor, the medium comprising one or more computer-readable instructions, the microprocessor executing the one or more computer-readable instructions to:
access a default event schedule comprising a plurality of events to be attended by a user;
access an event stress corresponding to each of the plurality of events;
access a stress threshold associated with the user;
determine whether a configuration of the plurality of events, in the default event schedule, will produce an aggregate stress, determined from the combination of event stresses for each of the plurality of events, that will exceed the stress threshold;
upon determining the stress threshold will not be exceeded, publish the default event schedule to a repository to automatically configure the resource allocated with the default event schedule; and
upon determining the stress threshold will be exceeded, recalculate the default event schedule to create a modified event schedule that attenuates the aggregate stress and publish the modified event schedule to the repository to automatically configure the resource allocated with the modified event schedule.

2. The system of claim 1, further comprising:
a monitoring component; and
wherein at least one event stress for a corresponding at least one of the plurality of events is determined from output signals from the monitoring component monitoring the user.

3. The system of claim 2, wherein the output signals are obtained from the monitoring component monitoring the user during at least one of a time ending with the start of the at least one of the plurality of events or beginning with the end of the at least one of the plurality of events.

4. The system of claim 2, wherein the monitoring component comprises a microphone receiving speech from the user and wherein the at least one event stress is determined from analyzing the speech for stress indicators.

5. The system of claim 2, wherein the monitoring component comprises a video camera receiving an image from the user and wherein the at least one event stress is determined from analyzing the physical appearance of the user for stress indicators.

6. The system of claim 1, wherein recalculating the default event schedule to create the modified event schedule that attenuates the aggregate stress, further comprises reassigning at least one of the plurality of events to a second user different from the user.

7. The system of claim 1, wherein recalculating the default event schedule to create the modified event schedule that attenuates the aggregate stress, further comprises inserting a low-stress event, between two of the plurality of events, to cause the time therebetween to be extended.

8. The system of claim 1, wherein determining the event stress corresponding to one of the plurality of events comprises providing an output signal from a monitoring component monitoring the user to a neural network trained to determine the event stress therefrom.

9. The system of claim 8, wherein training the neural network for event stress determination comprises:
collecting a set of output signals from a database;
applying one or more transformations to each output signal including increasing the rate of speech, decreasing the rate of speech, increasing the amount of speech flutter, decreasing the amount of speech flutter, increasing the pitch of speech, decreasing the pitch of speech, increasing a rate of typing, decreasing the rate of typing, replacing a typed word with a synonymous word or words having a different stress value, altering eye movement of the user, altering facial expression of the user, or altering body position of the user to create a modified set of output signals;
creating a first training set comprising the collected set of output signals, the modified set of output signals, and a set of low-stress output signals;
training the neural network in a first stage using the first training set;
creating a second training set for a second stage of training comprising the first training set and low-stress output signals incorrectly detected as event stress after the first stage of training; and
training the neural network in the second stage using the second training set.

10. A method for scheduling a resource, comprising:
accessing a default event schedule comprising a plurality of events to be attended by a user;
accessing an event stress corresponding to each of the plurality of events;
accessing a stress threshold associated with the user;
determining whether a configuration of the plurality of events in the default event schedule will produce an aggregate stress, determined from a combination of event stresses for each of the plurality of events, that will exceed the stress threshold;
upon determining the stress threshold will not be exceeded, publishing the default event schedule to a repository to automatically configure the resource allocated with the default event schedule; and
upon determining the stress threshold will be exceeded, recalculating the default event schedule to create a modified event schedule that attenuates the aggregate stress and publishing the modified event schedule to the repository to automatically configure the resource allocated with the modified event schedule.

11. The method of claim 10, wherein at least one event stress for a corresponding at least one of the plurality of events is determined from output signals from a monitoring component monitoring the user.

12. The method of claim 11, further comprising obtaining the output signals from the monitoring component monitoring the user during at least one of a time ending with the start of the at least one of the plurality of events or beginning with the end of the at least one of the plurality of events.

13. The method of claim 11, wherein the monitoring component comprises a microphone receiving speech from the user and wherein the at least one event stress is determined from analyzing the speech for stress indicators.

14. The method of claim 11, wherein the monitoring component comprises a video camera receiving an image from the user and wherein the at least one event stress is determined from analyzing the physical appearance of the user for stress indicators.

15. The method of claim 10, wherein recalculating the default event schedule to create the modified event schedule that attenuates the aggregate stress, further comprises reassigning at least one of the plurality of events to a second user different from the user.

16. The method of claim 10, wherein recalculating the default event schedule to create the modified event schedule that attenuates the aggregate stress, further comprises inserting a low-stress event, between two of the plurality of events, to cause the time therebetween to be extended.

17. The method of claim 10, wherein determining the event stress corresponding to one of the plurality of events comprises providing an output signal from a monitoring component monitoring the user to a neural network trained to determine the event stress therefrom.

18. The method of claim 17, wherein training the neural network for event stress determination comprises:
collecting a set of output signals from a database;
applying one or more transformations to each output signal including increasing the rate of speech, decreasing the rate of speech, increasing the amount of speech flutter, decreasing the amount of speech flutter, increasing the pitch of speech, decreasing the pitch of speech, increasing a rate of typing, decreasing the rate of typing, replacing a typed word with a synonymous word or words having a different stress value, altering eye movement of the user, altering facial expression of the user, or altering body position of the user to create a modified set of output signals;
creating a first training set comprising the collected set of output signals, the modified set of output signals, and a set of low-stress output signals;
training the neural network in a first stage using the first training set;
creating a second training set for a second stage of training comprising the first training set and low-stress output signals incorrectly detected as event stress after the first stage of training; and
training the neural network in the second stage using the second training set.

19. A system, comprising:
a server, the server further comprising at least one microprocessor and a computer-readable medium coupled to each of the at least one microprocessor, the medium comprising one or more computer-readable instructions, the at least one microprocessor executing the one or more computer-readable instructions to:
access a default event schedule comprising a plurality of events to be attended by a plurality of users;
access an event stress corresponding to each of the plurality of events;
access a stress threshold associated with each of the plurality of users;
determine whether a configuration of the plurality of events, in the default event schedule, will produce an aggregate stress, determined from the combination of event stresses for each of the plurality of events, that will exceed the stress threshold;
upon determining the stress threshold will not be exceeded, publish the default event schedule to a repository to automatically configure a resource allocated with the default event schedule; and
upon determining the stress threshold will be exceeded, recalculate the default event schedule to create a modified event schedule that attenuates the aggregate stress and publish the modified event schedule to the repository to automatically configure the resource allocated with the modified event schedule.

20. The system of claim 19, wherein recalculating the default event schedule further comprises assigning at least one event of the plurality of events to a first of the plurality of users different from a second of the plurality of users.
